(19) United States
(12) Patent Application Publication
(10) Pub. No.: US 2020/0211166 A1
(43) Pub. Date: Jul. 2, 2020

(54) METHODS AND APPARATUS FOR MOTION COMPENSATION IN HIGH DYNAMIC RANGE PROCESSING

(71) Applicant: QUALCOMM Incorporated, San Diego, CA (US)

(72) Inventors: Yihe YAO, San Diego, CA (US); Chien Chen CHEN, Taipei (TW); Lei MA, San Diego, CA (US); WenHao LIN, New Taipei City (TW); Fanxing KONG, San Diego, CA (US)

(21) Appl. No.: 16/236,147

(22) Filed: Dec. 28, 2018

(51) Int. Cl. G06T 5/00; H04N 5/232; G06T 3/00; G06T 7/20

(52) U.S. Cl. CPC G06T 5/009; H04N 5/23232; G06T 2207/20221; G06T 7/20; G06T 2207/20021; G06T 3/0093

(57) ABSTRACT

The present disclosure relates to methods and devices for high dynamic range (HDR) processing. In one aspect, the device may generate multiple frames, each frame being generated through a line-based exposure at a camera image sensor. The multiple frames can have at least two different exposure times and have staggered line-based exposure times during the at least two different exposure times. Additionally, the device can obtain movement information associated with the camera image sensor from a gyroscope sensor. The device can also modify the multiple frames based on the obtained movement information from the gyroscope sensor. Moreover, the device can combine the multiple frames into a staggered HDR image. The device can also generate a de-warp mesh for each frame based on the obtained movement information from the gyroscope sensor, and each frame can be modified based on its corresponding generated de-warp mesh.

### TECHNICAL FIELD

The present disclosure relates generally to processing systems and, more particularly, to one or more techniques for high dynamic range (HDR) processing in processing systems.

### INTRODUCTION

Computing devices often utilize an image signal processor (ISP), a central processing unit (CPU), a graphics processing unit (GPU), an image processor, or a video processor to accelerate the generation of image, video, or graphical data. Such computing devices may include, for example, computer workstations, mobile phones such as so-called smartphones, embedded systems, personal computers, tablet computers, and video game consoles. ISPs or CPUs can execute image, video, or graphics processing systems that includes multiple processing stages that operate together to execute image, video, or graphics processing commands and output one or more frames. In some aspects, a CPU may control the operation of one or more additional processors by issuing one or more image, video, or graphics processing commands. Modern day CPUs are typically capable of concurrently executing multiple applications, each of which may need to utilize another processor during execution. A device that provides content for visual presentation on a display generally includes an ISP or CPU.

ISPs or CPUs can be configured to perform multiple processes in an image, video, or graphics processing system. With the advent of faster communication and an increase in the quality of content, e.g., any content that is generated using an ISP or CPU, there has developed a need for improved image, video, or graphics processing.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects of the disclosure, a method, a computer-readable medium, and an apparatus are provided. The apparatus may be a high dynamic range (HDR) processor. In one aspect, the apparatus may generate multiple frames, each frame being generated through a line-based exposure at a camera image sensor. The multiple frames can have at least two different exposure times and have staggered line-based exposure times during the at least two different exposure times. Additionally, the apparatus can obtain movement information associated with the camera image sensor from a gyroscope sensor. The apparatus can also modify the multiple frames based on the obtained movement information from the gyroscope sensor. Moreover, the apparatus can combine the multiple frames into a staggered HDR image. The apparatus can also generate a de-warp mesh for each frame based on the obtained movement information from the gyroscope sensor, and each frame can be modified based on its corresponding generated de-warp mesh.

In some aspects, the apparatus can generate a de-warp mesh for each frame of the multiple frames based on the obtained movement information from the gyroscope sensor. Each frame can be modified based on its corresponding generated de-warp mesh. Also, the movement information can comprise a multiple sets of movement data, each at a different time, and each de-warp mesh can be divided into multiple blocks bᵢⱼ, where i can be the i^{th} row and 1≤i≤n, and j can be the j^{th} column and 1≤j≤m of the de-warp mesh. Blocks in row i can be modified based on different sets of movement data from the movement information from the gyroscope sensor. Additionally, each block bᵢⱼ of the de-warp mesh for a frame can indicate how to rotationally modify image data within the frame that overlaps with the block bᵢⱼ. In some aspects, the exposure times for the plurality of frames can be equal or increasing for each subsequent frame, where a last frame of the plurality of frames has a higher exposure time than a first frame of the plurality of frames. The exposure times for the plurality of frames can also be equal or decreasing for each subsequent frame, where a last frame of the plurality of frames has a lower exposure time than a first frame of the plurality of frames. The movement information associated with the camera image sensor can be obtained from the gyroscope sensor at a data acquisition frequency greater than or equal to 500 Hz. Moreover, the movement information can comprise angular velocity information. In some aspects, the multiple frames can comprise four frames. Additionally, the frames can be stored within one of a dynamic random access memory (DRAM) or application specific integrated circuit (ASIC) memory of an ASIC processor. The frames can also be modified within the DRAM or the ASIC processor. In some aspects, the apparatus can be a wireless communication device.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example system in accordance with the techniques of this disclosure.

FIG. 2 illustrates an example of HDR processing in accordance with the techniques of this disclosure.

FIG. 3 illustrates an example of HDR processing in accordance with the techniques of this disclosure

FIG. 4 is a block diagram that illustrates an example of an HDR processing system in accordance with the techniques of this disclosure.

FIG. 5 is a block diagram that illustrates an example of an HDR processing system in accordance with the techniques of this disclosure.

FIG. 6 illustrates an example of image alignment in accordance with the techniques of this disclosure.

FIG. 7 illustrates an example of image alignment in accordance with the techniques of this disclosure.

FIG. 8 illustrates an example flowchart of an example method in accordance with techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like, which can be collectively referred to as “elements.” These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors, which may also be referred to as processing units. Examples of processors include image signal processors (ISPs), central processing units (CPUs), graphics processing units (GPUs), image processors, video processors, microprocessors, microcontrollers, application processors, digital signal processors (DSPs), reduced instruction set computing (RISC) processors, systems on a chip (SoC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and executed the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can be a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to image content, HDR content, video content, graphical content, or display content. In some examples, as used herein, the phrases “image content” or “video content” may refer to content generated by a processing unit configured to perform image or video processing. For example, the phrases “image content” or “video content” may refer to content generated by one or more processes of an image or video processing system. In some examples, as used herein, the phrases “image content” or “video content” may refer to content generated by an ISP or a CPU. In some examples, as used herein, the term “display content” may refer to content generated by a processing unit configured to perform display processing. In some examples, as used herein, the term “display content” may refer to content generated by a display processing unit. Image or video content may be processed to become display content. For example, an ISP or CPU may output image or video content, such as a frame, to a buffer, e.g., which may be referred to as a frame buffer. A display processing unit may read the image or video content, such as one or more frames from the buffer, and perform one or more display processing techniques thereon to generate display content. For example, a display processing unit may be configured to perform composition on one or more generated layers to generate a frame. As another example, a display processing unit may be configured to compose, blend, or otherwise combine two or more layers together into a single frame. A display processing unit may be configured to perform scaling, e.g., upscaling or downscaling on a frame. In some examples, a frame may refer to a layer. In other examples, a frame may refer to two or more layers that have already been blended together to form the frame, i.e., the frame includes two or more layers, and the frame that includes two or more layers may subsequently be blended.

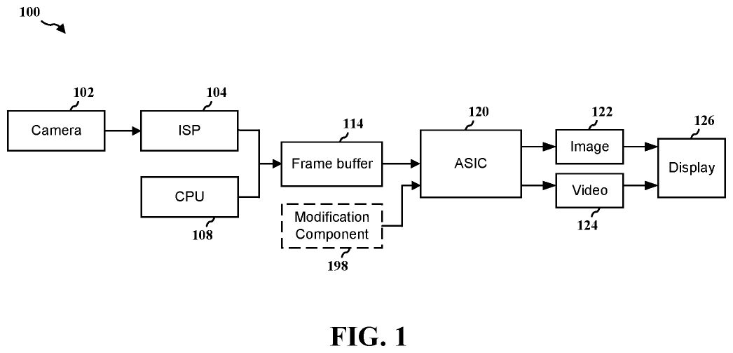

FIG. 1 is a block diagram illustrating system 100 configured to implement one or more techniques of this disclosure. The system 100 can include camera 102, ISP 104, CPU 108, frame buffer 114, ASIC 120, image processing unit 122, video processing unit 124, display 126, and modification component 198. Camera 102 can generate multiple frames via a variety of processing types. For instance, camera 102 can utilize any type of image or HDR processing, including snapshot or traditional processing, zig zag processing, spatial processing, and/or staggered processing. Additionally, ISP 104 can process the multiple frames from camera 102. Also, the frame buffer 114 can be stored or saved in a system memory or internal memory, e.g., a DRAM. In some aspects, the ASIC 120 can be part of, or contained in, the CPU 108. In other aspects, the system 100 may not include an ASIC. In yet other aspects, the image processing unit 122 and the video processing unit 124 can be a single image/video processing unit.

In some aspects, CPU 108 can run or perform a variety of algorithms for system 100. CPU 108 may also include one or more components or circuits for performing various functions described herein. For instance, the CPU 108 may include a processing unit, a content encoder, a system memory, and/or a communication interface. The processing unit, a content encoder, or system memory may each include an internal memory. In some aspects, the processing unit or content encoder may be configured to receive a value for each component, e.g., each color component of one or more pixels of image or video content. As an example, a pixel in the red (R), green (G), blue (B)(RGB) color space may include a first value for the red component, a second value for the green component, and a third value for the blue component. The system memory or internal memory may include one or more volatile or non-volatile memories or storage devices. In some examples, the system memory or the internal memory may include random access memory (RAM), static RAM (SRAM), dynamic RAM (DRAM), erasable programmable ROM (EPROM), electrically erasable programmable ROM (EEPROM), flash memory, a magnetic data media, an optical storage media, or any other type of memory.

The system memory or internal memory may also be a non-transitory storage medium according to some examples. The term “non-transitory” may indicate that the storage medium is not embodied in a carrier wave or a propagated signal. However, the term “non-transitory” should not be interpreted to mean that the system memory or internal memory are non-movable or that its contents are static. As one example, the system memory or internal memory may be removed from the CPU 108 and moved to another component. As another example, the system memory or internal memory may not be removable from the CPU 108.

CPU 108 may also include a processing unit, which may be an ISP, a GPU, an image processor, a video processor, or any other processing unit that may be configured to perform image or video processing. In some examples, the processing unit may be integrated into a component of the CPU 108, e.g., a motherboard, or may be otherwise incorporated within a peripheral device configured to interoperate with the CPU 108. The processing unit of CPU 108 may also include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit may store instructions for the software in a suitable, non-transitory computer-readable storage medium, e.g., system memory or internal memory, and may execute the instructions in hardware using one or more processors to perform the techniques of this disclosure. Any of the foregoing, including hardware, software, a combination of hardware and software, etc., may be considered to be one or more processors.

In some aspects of system 100, the frame buffer 114 can be stored or saved in a memory, e.g., the system memory or internal memory. In other instances, the frame buffer can be stored, saved, or processed in the ASIC 120. ASIC 120 can process the images or frames after the ISP 104. Additionally, ASIC 120 can process the contents of the frame buffer 414. In other aspects, the ASIC 120 can include a programmable engine, e.g., a processing unit or GPU. As mentioned herein, the CPU 108 may include a system memory that can store or save the frame buffer 114.

In another aspect of system 100, image processing unit 122 or video processing unit 124 can receive the images or frames from ASIC 120. For instance, in some aspects, image processing unit 122 or video processing unit 124 can process or combine the multiple frames from ASIC 120. Image processing unit 122 or video processing unit 124 can then send the frames to display 126. In some aspects, the display 126 may include a display processor to perform display processing on the multiple frames. More specifically, the display processor may be configured to perform one or more display processing techniques on the one or more frames generated by the camera 102, e.g., via image processing unit 122 or video processing unit 124.

In some aspects, the display 126 may be configured to display content that was previously generated. For instance, the display 126 may be configured to display or otherwise present the aforementioned frames. In some aspects, the display 126 may include one or more of a variety of display devices, such as a liquid crystal display (LCD), a plasma display, an organic light emitting diode (OLED) display, a projection display device, an augmented reality display device, a virtual reality display device, a head-mounted display, and/or any other type of display device. Display 126 may also include a single display or multiple displays, such that any reference to display 126 may refer to one or more displays 126. For example, the display 126 may include a first display and a second display. In some instances, the first display may be a left-eye display and the second display may be a right-eye display. In these instances, the first and second display may receive different frames for presentment thereon. In other examples, the first and second display may receive the same frames for presentment thereon.

Referring again to FIG. 1, in certain aspects, the system 100 may include a modification component 198 configured to generate multiple frames, each frame being generated through a line-based exposure at a camera image sensor. In some aspects of line-based exposure, each frame can be divided into different lines or sections. Each of the pixels in a line of a frame can be exposed at the same time. Pixels in different lines of the frame can be exposed at different times. The multiple frames can have at least two different exposure times and have staggered line-based exposure times during the at least two different exposure times. Additionally, the modification component 198 can obtain movement information associated with the camera image sensor from a gyroscope sensor. The modification component 198 can also modify the multiple frames based on the obtained movement information from the gyroscope sensor. Moreover, the modification component 198 can combine the multiple frames into a staggered HDR image. In some aspects, the modification component 198 can also generate a de-warp mesh for each frame based on the obtained movement information from the gyroscope sensor, and each frame can be modified based on its corresponding generated de-warp mesh. In some aspects, the processes described for the modification component 198 can be performed by the CPU 108. Other example benefits are described throughout this disclosure.

Aspects of the present disclosure described herein cover a wide range of image or video processing, such as HDR processing. In some aspects of HDR processing, multiple frames can be processed with different exposure times. For instance, the multiple frames can have two or more exposure time intervals. In some instances, the frames described herein can have an exposure time range of 1 millisecond (ms) to 30 ms, e.g., in the case of a frame rate of 30 frames-per-second (fps). Frames within the exposure range can have different exposure times, which can create an exposure time mismatch amongst frames. For example, some frames may have a short exposure time, e.g., 1 ms, and other frames can have a long exposure time, e.g., 30 ms. This mismatch of different frame exposure times can be the result of the camera environment, e.g., when the camera experiences motion. For instance, this exposure mismatch can occur when there is fast camera motion, e.g., when using a dash camera for automobiles. This mismatch of frame exposure times can lead to a number of processing issues, such as image breakup issues. This technical problem can be solved by generating frames through a line-based exposure at a camera image sensor, obtaining movement information associated with the camera image sensor from a gyroscope sensor, and/or modifying the frames based on the obtained movement information, as described in further detail below.

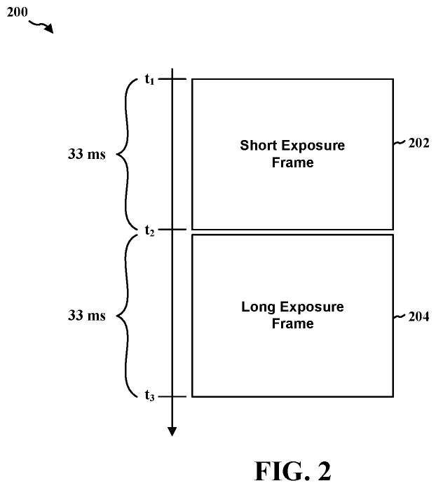

FIG. 2 illustrates an example of HDR processing 200 in accordance with the techniques of this disclosure. As mentioned above, some aspects of HDR processing can generate frames with different exposure times. These frames with multiple exposure times can be generated by a sensor, e.g., a camera image sensor. These frames can also readout from the sensor sequentially, i.e., pixels can be transferred from the sensor to another aspect of the camera. In some aspects, the exposure times can be longer than the readout times. In other aspects, the readout times may be longer than the exposure times. FIG. 2 shows that frames with two different exposures, short exposure frame 202 and long exposure frame 204, are generated at a camera sensor. In some aspects, short exposure frame 202 can have an exposure time of 1 ms, while long exposure frame 204 can have an exposure time of 30 ms. As further shown in FIG. 2, HDR processing 200 has times t₁, t₂, and t₃, where the time period between t₁ and t₂ is 33 ms and the time period between t₂ and t₃ is also 33 ms. Also, the time period between t₁ and t₂ can be the generation period for short exposure frame 202, while the time period between t₂ and t₃ can be the generation period for long exposure frame 204. FIG. 2 displays one type of HDR processing where different frames are generated in sequence, and the different frames are not staggered or overlapped.

Some aspects of the present disclosure can also include other types of HDR processing. For instance, the present disclosure can utilize staggered HDR processing, which is a temporal HDR solution that can provide multiple exposure times from a sensor image. Staggered HDR processing can be different from some aspects of the aforementioned multi-frame HDR processing, e.g., the generation period of the two or more exposure frames can be shorter. In some instances, the generation period can be less than a frame exposure time. In other instances, the generation period can be greater than a frame exposure time. As mentioned above, in some aspects of HDR processing, the multiple exposure frames can have a generation period of 33 ms. In staggered HDR processing, the generation period can be shorter, e.g., less than 10 ms. Moreover, some types of HDR processing can utilize gyroscope assisted motion that is applied to assist the motion detection.

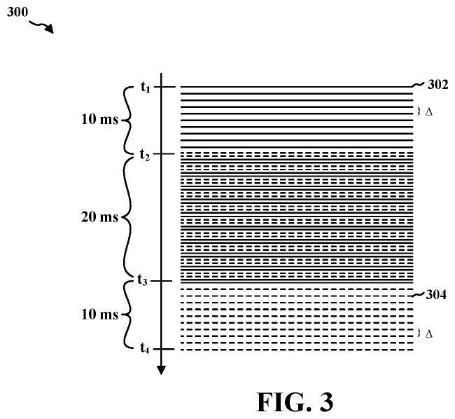

FIG. 3 illustrates another example of HDR processing 300 in accordance with the techniques of this disclosure. More specifically, HDR processing 300 is a type of staggered HDR processing. As indicated above, staggered HDR processing can utilize line-based sensor exposures to generate frames. For instance, staggered HDR processing can use different line-based exposures to generate frames with different exposure times. As shown in FIG. 3, HDR processing 300 can generate multiple frames, where each frame is generated through a line-based exposure at a camera image sensor. For example, short exposure frames can be generated through short exposure lines 302 and long exposure frames can be generated through long exposure lines 304. Also, the multiple frames can have at least two different exposure times, e.g., short exposure frames and long exposure frames. As shown in FIG. 3, in some instances, the multiple frames can include one short exposure frame generated through short exposure lines 302 and one long exposure frame generated through long exposure lines 304. Further, the multiple frames can have staggered line-based exposure times during the at least two different exposure times, e.g., short exposure lines 302 and long exposure lines 304 can be staggered during the generation of short exposure frames and long exposure frames.

As indicated above, HDR processing 300 can use a staggered approach to stagger the different exposure times through a line-based exposure system. For example, HDR processing 300 can stagger the line-based exposures for frames with different exposure times, e.g., short and long exposure frames. In some aspects, the short exposure frames may be generated with the line-based exposures before the long exposure frames, e.g., short exposure lines 302 may begin before long exposure lines 304. In other aspects, the long exposure frames may be generated with the line-based exposures prior to the short exposure frames, e.g., long exposure lines 304 may begin before short exposure lines 302.

As shown in FIG. 3, HDR processing 300 includes two different types of line-based exposures: short exposure lines 302 that are indicated with solid black lines and long exposure lines 304 that are indicated with dashed lines. As mentioned above, short exposures frames can be generated with short exposure lines 302 and long exposure frames can be generated with long exposure lines 304. FIG. 3 also displays times t₁, t₂, t₃, and t₄. At t₁, the first short exposure line 302 can begin generating a short exposure frame. At t₁ plus some value Δ, e.g., 10 μs, another short exposure line 302 can be used to generate the short exposure frame. The time period between each short exposure line 302 can be the value Δ, e.g., 10 μs. In some aspects, each short exposure frame generated by short exposure lines 302 can have an exposure time of 1 ms. Also, each long exposure frame generated by long exposure lines 304 can have an exposure time of 30 ms.

As shown in FIG. 3, the time period between t₁ and t₂ can be 10 ms, the time period between t₂ and t₃ can be 20 ms, and the time period between t₃ and t₄ can be 10 ms. In some aspects, the time period between t₁ and t₂ may only include the short exposure lines 302. The time period between t₂ and t₃ may include both the short exposure lines 302 and the long exposure lines 304. Also, the time period between t₃ and t₄ may only include the long exposure lines 304. Accordingly, the time period between t₂ and t₃ may have overlap between the short exposure lines 302 and the long exposure lines 304. As shown in FIG. 3, the overlapping period between t₂ and t₃ may alternate between short exposure lines 302 and long exposure lines 304, e.g., once every two lines.

At t₂, the first long exposure line 304 can begin generating a long exposure frame. As such, in some aspects, the start of the long exposure lines 304 can be delayed from the start of the short exposure lines 302 by a period of 10 ms. As indicated previously, this delay period between different exposure lines can be shorter than other types of HDR processing. Therefore, in some aspects, staggered HDR processing can be more suitable for a faster moving camera, as the long exposure lines are closer to the short exposure lines. At t₂ plus some value Δ, e.g., 10 μs, another long exposure line 304 can be used to generate the long exposure frame. The time period between each long exposure line 304 can be the value Δ, e.g., 10 μs. At t₃, the short exposure lines 302 may stop generating a short exposure frame. Accordingly, the short exposure lines 302 may run from t₁ to t₃, e.g., 30 ms, so the amount of time to generate a short exposure frame may be 30 ms. As indicated in FIG. 3, the time period between t₃ and t₄ may only include the long exposure lines 304. As such, the long exposure lines 304 may run from t₂ to t₄, e.g., 30 ms, so the amount of time to generate a long exposure frame may also be 30 ms. As the amount of time from t₁ to t₄ is 40 ms, the total amount of time to generate both the short and long exposure frames may be 40 ms. In contrast, other types of HDR processing may take a longer period of time to generate frames. For example, it may take 66 ms to generate both a short and long exposure frame with other types of HDR processing. Thus, at least one benefit of staggered HDR processing can be to reduce the time period that it takes to generate the frames.

As indicated in FIG. 3, a sensor may use a number of short and long exposure lines in order to generate short and long exposure frames. For example, as there are 3,000 occurrences of 10 μs within a time period of 30 ms, HDR processing 300 can utilize 3,000 short exposure lines 302 to generate a short exposure frame, as well as 3,000 long exposure lines 304 to generate a long exposure frame. Accordingly, in some aspects, there can be a total of 6,000 short exposure lines 302 and long exposure lines 304 from t₁ to t₄.

In other aspects of HDR processing, e.g., snapshot HDR or traditional HDR, real time processing may not be required. In these types of HDR processing, the processing algorithms can perform image registration to align the frames during the generation period. Other aspects of HDR processing, e.g., zig zag HDR (zzHDR) or spatial HDR (iHDR), may use real time processing to solve issues such as motion artifacts. For instance, spatial HDR maps frames spatially, such that frames with different exposure times are mapped in an alternating fashion. In zig zag HDR, the different frames are mapped in a zig zag pattern by spatially dividing the pixels into groups for different exposure times. In spatial HDR, there is no full resolution image of the different exposure frames. Further, spatial HDR may not suffer from global motion, so the different frames can be exposed at the same time. However, these types of HDR processing can sacrifice signal-to-noise ratio (SNR) in order to solve the aforementioned issue. For example, in the case of global motion, the entire image may only utilize the frames with short exposure, which can result in a corresponding decrease in SNR.

Aspects of the present disclosure can utilize staggered HDR processing to account for issues with camera motion without experiencing any of the aforementioned issues in other types of HDR processing. Some potential applications for the staggered HDR processing solution of the present disclosure are applications with severe motion issues, e.g., dash cameras for automobiles. This type of camera can experience severe camera motion, e.g., if it is mounted to a fast moving automobile. As mentioned above, this severe camera motion is a prime target for staggered HDR processing solutions of the present disclosure.

In some aspects of staggered HDR processing, a processing algorithm can register the images in order to perform the image registration and align the different exposure frames. However, this can require a large computational load to account for the large data content. Further, some instances of staggered HDR processing may have issues with image quality, e.g., instances of image breakup. The present disclosure can solve these computational issues by utilizing a gyroscope sensor with staggered HDR processing. For example, in some aspects, the camera motion can be calculated and/or corrected, e.g., in order to align frames with different exposure times, through the use of a gyroscope sensor.

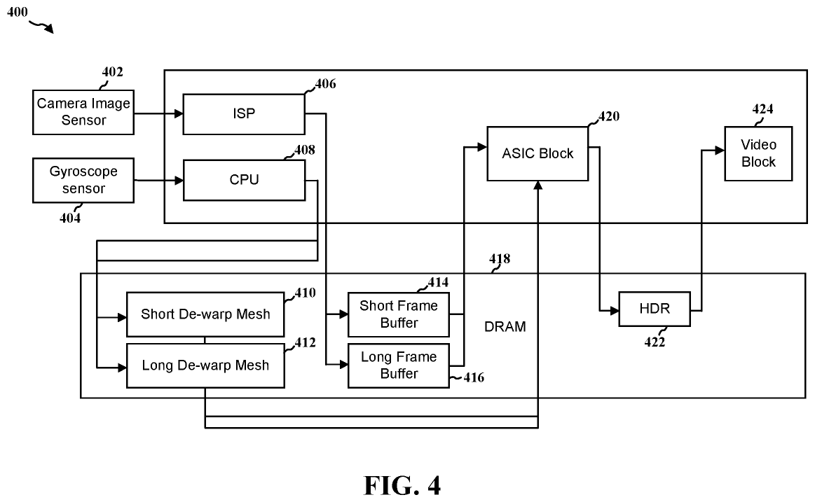

FIG. 4 is a block diagram illustrating HDR processing system 400. As shown in FIG. 4, HDR processing system 400 includes camera image sensor 402, gyroscope sensor 404, ISP 406, CPU 408, short de-warp mesh 410, long de-warp mesh 412, short frame buffer 414, long frame buffer 416, DRAM 418, ASIC block 420, HDR processor 422, and video block 424. In some aspects, HDR processing system 400 can begin processing at camera image sensor 402. For instance, camera image sensor 402 can generate multiple frames through a line-based exposure. The multiple frames generated by camera image sensor 402 can have two or more different exposure times, e.g., a short exposure time and a long exposure time. In some aspects, the exposure times for the multiple frames can be equal or increasing for each subsequent frame, where a last frame of the multiple frames can have a higher exposure time than a first frame. In other aspects, the exposure times for the multiple frames can be equal or decreasing for each subsequent frame, where a last frame of the multiple frames can have a lower exposure time than a first frame. Also, the multiple frames can have staggered line-based exposure times during the at least two different exposure times. As mentioned previously, this staggered line-based exposure means that HDR processing system 400 can support staggered HDR processing.

In another aspect of HDR processing system 400, gyroscope sensor 404 can supply movement information associated with the camera image sensor 402. Accordingly, HDR processing system 400 can obtain movement information associated with the camera image sensor 402 from a gyroscope sensor 404. In some instances, the movement information associated with the camera image sensor 402 can be obtained from the gyroscope sensor 404 at a data acquisition frequency or sampling frequency greater than or equal to 500 Hz. Indeed, the gyroscope sensor 404 can operate at a high frequency of data acquisition, e.g., approximately 500 Hz to approximately 3 kHz. In some aspects, this high operation frequency may be useful to correct certain camera issues, such as a rolling shutter effect of the camera. A rolling shutter effect can cause an exposure timing inconsistency for the different exposure lines, i.e., the delay of each line-based exposure generated by the camera image sensor 402 may be inconsistent. This rolling shutter effect can cause the images to be distorted. Accordingly, by operating the gyroscope sensor 404 at a high frequency, it can offset any potential issues, such as a rolling shutter effect. In some aspects, the gyroscope sensor 404 may operate at a higher sampling rate than the camera image sensor 402. In yet other aspects, the gyroscope sensor 404 may operate at a lower sampling rate than the camera image sensor 402.

The present disclosure can also utilize the gyroscope sensor 404 in order to obtain different movement information, such as the motion angle of the camera. In some aspects, the gyroscope sensor 404 can obtain different movement or rotation data at different time periods. For instance, the gyroscope sensor 404 can obtain movement information for different locations in a frame at different times. The gyroscope sensor 404 can also run in staggered HDR mode, as the gyroscope sensor can support the staggered timing of the exposure frames. The present disclosure can also measure the camera motion or rotation at the gyroscope sensor 404. In some aspects, the movement, acceleration, and/or rotation of the camera can be used to perform measurements at the gyroscope sensor 404. In other aspects, the gyroscope sensor 404 may only use the rotation of the camera to perform the necessary measurements. Additionally, the movement information obtained from the gyroscope sensor 404 can include a variety of different information, such as angular velocity information.

In another aspect of HDR processing system 400, ISP 406 can process the frames from the camera image sensor 402. As camera image sensor 402 can generate multiple frames having two or more different exposure times, e.g., a short exposure time and a long exposure time, the ISP 406 can process those multiple frames. As such, the multiple frames processed by ISP 406 can be a short exposure frame and a long exposure frame. In some aspects, the short frame buffer 414 and the long frame buffer 416 can be stored or saved in the DRAM 418. Accordingly, the short exposure frames and a long exposure frames can be generated by the camera image sensor 402, processed in the ISP 406, and then saved in the DRAM 418. In other aspects, the short frame buffer 414 and the frame buffer 416 can be modified or processed directly in the ASIC block 420. The short frame buffer 414 and the long frame buffer 416 can also be stored or saved in the ASIC block 420.

In another aspect of HDR processing system 400, CPU 408 can run an electronic image stabilization (EIS) algorithm. In some instances, the EIS algorithm can be performed based on the obtained movement information from the gyroscope sensor 404. After the EIS algorithm is performed, the CPU 408 can output different mesh tables or multiple de-warp meshes. In some aspects, the EIS algorithm can calculate a de-warp mesh for each type of exposure frame, e.g., based on the movement information obtained from the gyroscope sensor 404. The mesh tables or de-warp meshes can align the different images or frames into the same position or camera perspective. The EIS algorithm in accordance with the techniques of this disclosure can support any number of frames with different exposures. For example, the EIS algorithm can support two different exposures, e.g., a short exposure frame and a long exposure frame. Also, the EIS algorithm can support four different exposures. In some aspects, the number of exposures may be limited by the camera image sensor 402. For instance, the camera image sensor 402 may support a certain number of different exposure times, e.g., two or four different exposures. Accordingly, in some aspects, HDR processing system 400 can include two or four different exposure frames.

As shown in FIG. 4, the CPU 408 can output multiple de-warp meshes, e.g., to the ASIC block 420, for different exposure lengths, such as a mesh for short exposure frames, e.g., short de-warp mesh 410, and mesh for long exposure frames, e.g., long de-warp mesh 412. In some aspects, the short de-warp mesh 410 and the long de-warp mesh 412 can modify the multiple frames based on the obtained movement information from the gyroscope sensor 404. The calculation of the de-warp mesh or camera rotation can be based on the rotation information obtained from the gyroscope sensor 404. As indicated previously, the short de-warp mesh 410 can modify short exposure frames, while the long de-warp mesh 412 can modify long exposure frames. Accordingly, the HDR processing system 400 can generate the short de-warp mesh 410 and the long de-warp mesh 412 based on the obtained movement information from the gyroscope sensor 404. Once the short de-warp mesh 410 and long de-warp mesh 412 are generated, each frame can then be modified based on its corresponding de-warp mesh.

HDR processing system 400 can include both short de-warp mesh 410 and long de-warp mesh 412 because the image content for the short and long exposure frames may be different. For instance, the images produced at the short exposure frames and the long exposure frames may be rotated or aligned differently. This can be attributed to a difference in camera movement or a change in camera perspective, e.g., based on the different exposure times. Once the short and long exposure frames are run through the corresponding de-warp meshes 410 and 412, the de-warp meshes can align the images in the short and long exposure frames with each another. Indeed, the short de-warp mesh 410 and the long de-warp mesh 412 may determine how to de-rotate or align the short and long exposure frames. Essentially, the de-warp meshes 410 and 412 can take a warped or misaligned frame image and de-warp or align that image, e.g., by rotating the image. In some aspects, the de-warp meshes 410 and 412 may attempt to de-warp the short and the long exposure frames simultaneously. In other aspects, the de-warp meshes 410 and 412 may align frames at slightly different time periods. As such, aspects of the present disclosure can perform additional processing between the short and the long exposure frames to help the frames align with one another.

In another aspect of HDR processing system 400, ASIC block 420 can assist with the process of aligning the short and the long exposure frames. For instance, the ASIC block 420 can process the images after short de-warp mesh 410 and long de-warp mesh 412. In other aspects, the ASIC block 420 can process the short frame buffer 414 and the long frame buffer 416. The ASIC block 420 can also include a programmable engine, e.g., a processing unit or GPU. In some instances, the ASIC block 420 or programmable engine can process the images after the short de-warp mesh 410 and the long de-warp mesh 412, and then internally align the different exposure frames. The ASIC block 420 can also perform additional aspects of the HDR processing, e.g., fusing or combining the images from the short de-warp mesh 410 and the long de-warp mesh 412, tone mapping, and/or other types of ISP functionality. Indeed, the ASIC block 420 can fuse or combine the images from the short de-warp mesh 410 and the long de-warp mesh 412 into a single image. ASIC block 420 can also store the relative motion of the different exposure frames. In some instances, there may be more than two de-warp meshes, e.g., a number of N de-warp meshes, such that the ASIC block 420 can fuse or combine the frames or images from N de-warp meshes into N-1 frames or images.

In another aspect of HDR processing system 400, HDR processor 422 can obtain the frame or image data from the ASIC block 420 and perform the HDR processing on the images. For example, the HDR processor 422 can produce the HDR images from the image or frame data received from the ASIC block 420. In some instances, the HDR processor 422 can fuse or combine the multiple frames including different exposures into a staggered HDR image. In another aspect of HDR processing system 400, video block 424 can receive the HDR images or frames from HDR processor 422. For instance, in some aspects, the video block 424 can also combine the multiple frames including different exposures into a staggered HDR image. In further aspects, the video block 424 can help to combine or produce HDR video from the HDR images or frames.

In some aspects, HDR processing system 400 can also include a display, such that video block 424 can send the frames to the display. In these aspects, the display may include a display processor to perform display processing on the multiple frames. More specifically, the display processor may be configured to perform one or more display processing techniques on the one or more frames generated by the camera image sensor 402, e.g., via video block 424. In some instances, the display may be configured to display content that was previously generated. For example, the display may be configured to display or otherwise present frames that were previously processed by HDR processing system 400.

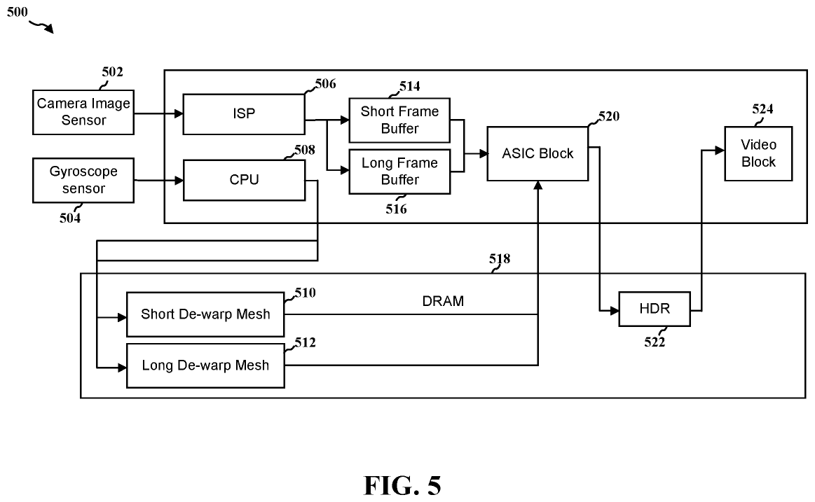

FIG. 5 is a block diagram illustrating HDR processing system 500. As shown in FIG. 5, HDR processing system 500 includes camera image sensor 502, gyroscope sensor 504, ISP 506, CPU 508, short de-warp mesh 510, long de-warp mesh 512, short frame buffer 514, long frame buffer 516, DRAM 518, ASIC block 520, HDR processor 522, and video block 524. FIG. 5 displays that HDR processing system 500 can have different component locations compared to HDR processing system 400. Indeed, FIG. 5 illustrates that the HDR processing systems in accordance with the techniques of this disclosure can include a variety of different embodiments or structures. For instance, in HDR processing system 500, the short frame buffer 514 and the frame buffer 516 can be processed directly in the ASIC block 520. Accordingly, the short exposure frames and a long exposure frames can be generated by the camera image sensor 502, processed in the ISP 506, and then processed directly in the ASIC block 520. In some aspects, the short frame buffer 514 and the long frame buffer 516 can be stored or saved in the ASIC block 520. In other aspects, as mentioned previously, the short frame buffer 514 and the long frame buffer 516 can be stored or saved in the DRAM 518. HDR processor 522 can obtain the frame or image data from the ASIC block 520 and perform the HDR processing on the images. Further, HDR processor 522 or video block 524 can combine the short exposure frames and a long exposure frames into a staggered HDR image.

As mentioned previously, the present disclosure can utilize de-warp meshes that process the alignment of the images in a novel manner. Traditional alignment solutions may use the same rotation value for each pixel in an entire image. However, the present disclosure can divide the images into multiple sections or blocks such that image is analyzed on a smaller, more fine-grained level. For instance, the present disclosure may calculate different rotations for many different pixels within the image. In some instances, the present disclosure may divide an image into multiple sections, e.g., sections of 128×96, such that there may be numerous different rotations, e.g., up to 12,288 rotations, within the same image. Indeed, the present disclosure can utilize a different alignment process for different sections of the image. In some instances, each pixel of the divided image may use a different rotation parameter. By doing so, the present disclosure can obtain a more accurate and precise image alignment.

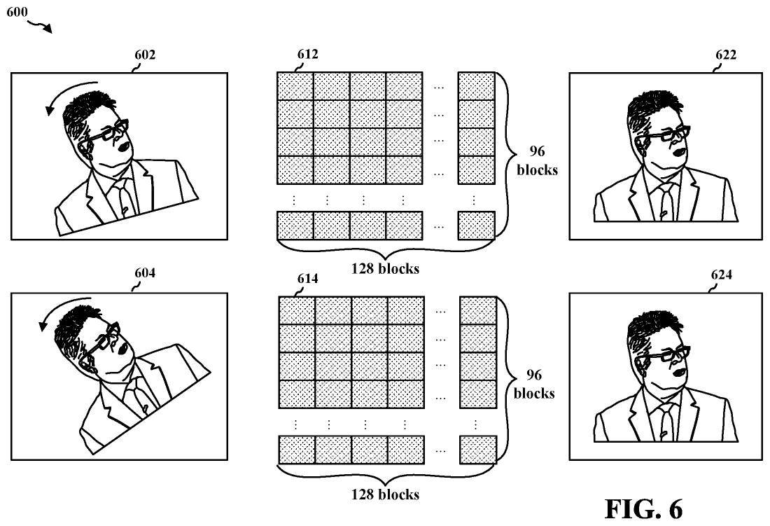

FIG. 6 illustrates image alignment 600 in accordance with the techniques of this disclosure. Image alignment 600 includes input short exposure frame 602, input long exposure frame 604, short de-warp mesh 612, long de-warp mesh 614, output short exposure frame 622, and output long exposure frame 624. Input short exposure frame 602 and input long exposure frame 604 can both include resolutions of 4160 by 3120 pixels. As further shown in FIG. 6, short de-warp mesh 612 and long de-warp mesh 614 can be tables including dimensions of 128 by 96. Additionally, output short exposure frame 622 and output long exposure frame 624 can also include resolutions of 4160 by 3120 pixels.

FIG. 6 shows an example of taking short and long exposure frames 602/604 generated using a line-based exposure at a camera image sensor, e.g., camera image sensors 402/502 in FIGS. 4 and 5, and combining the frames with motion information from a gyroscope sensor, e.g., gyroscope sensors 404/504 in FIGS. 4 and 5, and running them through different de-warp meshes, e.g., short de-warp meshes 410/510/612 and long de-warp meshes 412/512/614. As mentioned previous, the different de-warp meshes, e.g., short de-warp meshes 410/510/612 and long de-warp meshes 412/512/614, can be calculated using an EIS algorithm at a CPU, e.g., CPU 408/508. Accordingly, image alignment 600 can be used in conjunction with a larger HDR processing system, e.g., HDR processing systems 400/500 in FIGS. 4 and 5.

FIG. 6 displays that the input image alignment or rotation for the short and long exposures, e.g., input short exposure frame 602 and input long exposure frame 604, may be different. For instance, the image in input short exposure frame 602 and the image in input long exposure frame 604 are not aligned. This can be for a number of different reasons, such as camera motion or camera perspective change. Accordingly, if the camera is moving quickly, then the images generated through line-based exposure may be differently aligned for different exposure times, i.e., a short exposure frame alignment is different compared to a long exposure frame alignment.

In some aspects of image alignment 600, the short de-warp mesh 612 and the long de-warp mesh 614 can modify the input short exposure frame 602 and the input long exposure frame 604, respectively, based on obtained movement information from a gyroscope sensor, e.g., gyroscope sensor 404/504 in FIGS. 4 and 5. FIG. 6 illustrates that short de-warp mesh 612 and long de-warp mesh 614 can divide the images in input short exposure frame 602 and the input long exposure frame 604 into multiple sections or blocks, e.g., dimensions of 128 by 96 sections or blocks. For example, short de-warp mesh 612 and long de-warp mesh 614 can be grids including 128 by 96 sections. As such, short de-warp mesh 612 and long de-warp mesh 614 can process or rotate the images in input short exposure frame 602 and input long exposure frame 604 within blocks or sections of 128 by 96. For instance, different rows of short de-warp mesh 612 and long de-warp mesh 614 may use different rotation values based on movement information obtained from the gyroscope sensor. Also, different individual blocks of short de-warp mesh 612 and long de-warp mesh 614 can use different rotation values based on movement information from the lens. Accordingly, in some aspects, short de-warp mesh 612 and long de-warp mesh 614 can process up to 96 different rotations based on movement information from the gyroscope sensor, i.e., equal to the 96 rows in short de-warp mesh 612 and long de-warp mesh 614. Also, short de-warp mesh 612 and long de-warp mesh 614 can process up to 12,288 different rotations, i.e., 96 rows by 128 columns, based on movement information from the lens and/or gyroscope sensor. Further, each section or portion of the divided image in input short exposure frame 602 and input long exposure frame 604 may use a different rotation parameter from short de-warp mesh 612 and long de-warp mesh 614, respectively.

In some aspects, the EIS algorithm running on the CPU, e.g., CPU 408/508, can calculate the rotation between the different line-based exposures. Once the EIS algorithm calculates the rotational difference between the images of input short exposure frame 602 and input long exposure frame 604, the short de-warp mesh 612 and long de-warp mesh 614 can be applied to correctly align the images and produce the resulting output short exposure frame 622 and output long exposure frame 624. As mentioned above, in some aspects the different line-based exposures can be 10 ms apart. As such, the present disclosure can take into account the camera motion within that 10 ms. Further, the present disclosure can apply a different rotation for each section of the short and long exposure frames.

As mentioned previously, the different de-warp meshes can determine how to correctly align and/or de-rotate frames of different exposure lengths. In some aspects, the de-warp meshes can map a specific block or section in the input image to a specific block or section in the output image. For example, short de-warp mesh 612 and long de-warp mesh 614 can map a specific block in input short exposure frame 602 and input long exposure frame 604, respectively, to a specific block in output short exposure frame 622 and output long exposure frame 624, respectively. As indicated in FIG. 6, these specific sections can correspond to one of the 128 by 96 sections in the meshes 612/614. After the input short exposure frame 602 and input long exposure frame 604 are processed through the short de-warp mesh 612 and long de-warp mesh 614, respectively, the images can align in output short exposure frame 622 and output long exposure frame 624.

As shown in FIG. 6, the short de-warp mesh 612 and the long de-warp mesh 614 can include a number of different rows and columns, e.g., 96 rows and 128 columns. As the number of rows and columns can vary, each specific block or section within de-warp meshes 612/614 can be referred to as bᵢⱼ, where i is the i^{th} row and 1≤i≤n, and j is the j^{th} column and 1≤j≤m of the de-warp mesh. Also, each block or section bᵢⱼ of a de-warp meshes 612/614 can indicate how to rotationally modify image data within the corresponding frame, e.g., input short exposure frame 602 and input long exposure frame 604, that overlaps with the block bᵢⱼ. As mentioned above, each different row i, where 1≤i≤n, of short de-warp mesh 612 and long de-warp mesh 614 may use different rotation values based on movement information obtained from the gyroscope sensor. Also, different individual blocks bᵢⱼ of short de-warp mesh 612 and long de-warp mesh 614 can use different rotation values based on movement information from the lens. In some instances, n can be a function of a data acquisition frequency of the gyroscope sensor, e.g., gyroscope sensor 404/504. Also, de-warp meshes 612/614 can be generated based on obtained movement information from the gyroscope sensor, e.g., gyroscope sensor 404/504. The obtained movement information can include multiple sets of movement data, with each set of movement data corresponding to a different time. In further instances, the blocks in row i may be modified based on different sets of movement data from the movement information from the gyroscope sensor, e.g., gyroscope sensor 404/504.

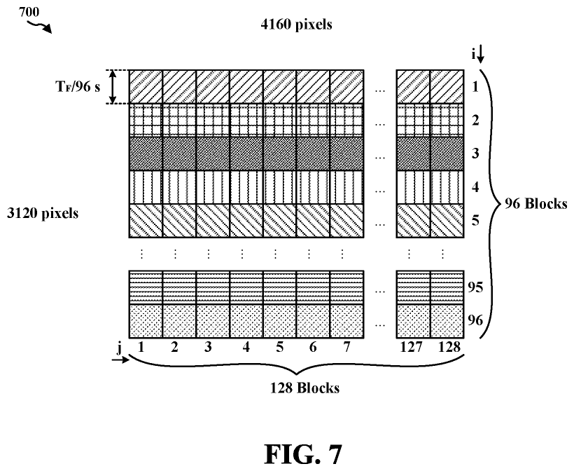

FIG. 7 illustrates image alignment 700 in accordance with the techniques of this disclosure. Image alignment 700 includes a number of different blocks, including 96 rows and 128 columns. More specifically, image alignment 700 displays an input image with a resolution of 4160 by 3120 pixels being run through a de-warp mesh with dimensions of 128 by 96 blocks. Accordingly, FIG. 7 shows an input image with 4160 by 3120 pixels being divided into a grid of 128 by 96 blocks from a de-warp mesh. As further shown in FIG. 7, the specific blocks in the de-warp mesh correspond to a specific location in the input image.

In some aspects, the size of the grid in a de-warp mesh in a vertical direction can be a function of the data acquisition speed of the gyroscope sensor. For instance, the size of a block in a grid may be shorter vertically if the data acquisition speed of the gyroscope sensor is increased. Likewise, the size of a grid block may be larger vertically if the data acquisition speed of the gyroscope sensor is decreased. Accordingly, slower data acquisition speeds at the gyroscope sensor can have larger block sizes in a vertical direction.

As mentioned previously, the present disclosure can take into account different rotations for the vertical and horizontal sections of the image. For example, each input image can be divided into a grid with dimensions of 128 by 96 sections or blocks. Each of the aforementioned sections or blocks may have its own rotation computation. As such, the present disclosure can divide an image from an exposure frame into a grid and each block in the grid can have its own rotation value.

As shown in FIG. 7, the de-warp mesh can include a number of different rows and columns, e.g., 96 rows and 128 columns. However, the number of rows and columns in the de-warp mesh can vary, so each specific block or section within the de-warp mesh can be referred to as bᵢⱼ, where i is the i^{th} row and 1≤i≤n, and j is the j^{th} column and 1≤j≤m of the de-warp mesh. Additionally, each block or section bᵢⱼ of the de-warp mesh can indicate how to rotationally modify image data within the input frame that overlaps with the block bᵢⱼ. In some instances, n can be a function of a data acquisition frequency of the gyroscope sensor, e.g., gyroscope sensor 404/504. The de-warp mesh can be generated based on obtained movement information from the gyroscope sensor, e.g., gyroscope sensor 404/504. Also, the obtained movement information can include multiple sets of movement data, with each set of movement data corresponding to a different time. The blocks in row i may also be modified based on different sets of movement data from the movement information from the gyroscope sensor, e.g., gyroscope sensor 404/504.

As mentioned above, each different row i, where 1≤i≤96, of the de-warp mesh in FIG. 7 may use different rotation values based on movement information obtained from the gyroscope sensor. Also, different individual blocks bᵢⱼ, where 1≤i≤96 and 1≤j≤128, of the de-warp mesh in FIG. 7 can use different rotation values based on information from the lens. Accordingly, in some aspects, the de-warp mesh in FIG. 7 can process up to 96 different rotations based on movement information from the gyroscope sensor, i.e., equal to the 96 rows in de-warp mesh. Also, the de-warp mesh can process up to 12,288 different rotations, i.e., 96 rows multiplied by 128 columns, based on information from the lens.

As indicated above, the rotation applied to each block, bᵢⱼ, of the de-warp mesh in FIG. 7 can be equal to the gyroscope information for row i and the lens distortion for each block value bᵢⱼ. For example, the rotation of each block, rᵢⱼ, can be a combination of the rotational value from the gyroscope for each row, gᵢ, and the distortion value from the lens for each block, lᵢⱼ. This can also be expressed as a formula: rᵢⱼ=gᵢ+lᵢⱼ. In some aspects, as shown in FIG. 7, there may be a different gyroscope rotational value for each row. Accordingly, each row can have its own gyroscope reading, e.g., g₁, g₂, g₃, etc. In other aspects, the gyroscope rotational value may change once every few rows. For instance, the gyroscope data may be the same for more than one row, such as every two or three rows, e.g., g₁, g₂, and g₃ may be the same value. The difference in gyroscope rotational values for each row may depend on how often the gyroscope is taking a reading of rotational data. Further, the distortion value from the lens can vary depending on the location of each block.

Additionally, the size of each block, bᵢⱼ, of the de-warp mesh in FIG. 7 can be related to the amount of time to generate a frame using the line-based exposure from the sensor. In some aspects, the total number of rows can be equivalent to the total time to generate a frame, T_{F}. For instance, as described in connection with FIG. 3, the total time to generate a short or long exposure frame, T_{F}, is 30 ms. As there are 96 rows in the de-warp mesh in FIG. 7, each row can correspond to T_{F}/96, i.e., 30 ms/96=312.5 μs. As stated above, in some aspects, the sampling frequency of the gyroscope can be approximately 500 Hz to 3,000 kHz, or equivalent to 0.5 to 3 μs. As 0.5 to 3 μs is faster than 312.5 μs, in some aspects, the gyroscope readings may update faster than the time to generate a row in the de-warp mesh in FIG. 7.

Based on the above, the size of each block, bᵢⱼ, of the de-warp mesh in FIG. 7 can be related to the number of line-based exposure lines used to generate a frame. For instance, the total number of lines used to generate a frame can correspond to the amount of rows in the de-warp mesh. As described in connection with FIG. 3, there are 3,000 short exposure lines 302 used to generate a short exposure frame and 3,000 long exposure lines 304 used to generate a long exposure frame. Accordingly, using either short exposure lines 302 or long exposure lines 304 in FIG. 3, the 96 rows in the de-warp mesh in FIG. 7 can correspond to 3,000 lines. Based on these values, 3,000/96 or 31.25 lines may correspond to one row of the de-warp mesh in FIG. 7. As such, 31.25 lines may receive the same rotational value from the gyroscope. This corresponds to the 312.5 μs calculation above, as 31.25 lines multiplied by 10 μs, i.e., the amount of time separating each line in the line-based exposure in FIG. 3, equals 312.5 μs. Accordingly, in some aspects, the present disclosure can calculate each row in the de-warp mesh every 312.5 μs.

As mentioned previously, in some aspects of the present disclosure, each exposure length there can be a corresponding mesh. By utilizing the mesh, the present disclosure can warp or de-warp the image to correct the camera motion. After utilizing the mesh, the present disclosure can align the short and long exposure images to the same camera perspective pose. However, the short and long exposure frames may have different levels of light exposure. Indeed, the short exposure frames may not be exposed to light for as long as the long exposure frames, so the brightness levels may differ between them.

After the images are aligned, the present disclosure can begin the HDR processing. As mentioned above, the HDR processing can occur at an HDR processor, e.g., HDR processor 422/522, which can fuse or combine the aligned images together. In some instances, each pixel value in the short exposure can be multiplied by an exposure value. For example, if the short exposure frame is 100 times darker than the long exposure frame, then the present disclosure can multiply the pixel value in the short exposure frame by 100.

In some aspects, the present disclosure can seek to correct global motion, i.e., when the camera is moving, but the scene is not moving. In other aspects, the present disclosure may seek to correct local motion, i.e., when the camera is static, but the scene is moving. In yet other aspects, the present disclosure can perform a setup test to determine whether local and/or global motion should be corrected. The present disclosure can also take into account any lens or geometric distortion. For instance, some types of cameras, e.g., dash cameras in automobiles, can use wide angles, which may cause the images to get slightly distorted. Accordingly, the present disclosure can correct for any lens or geometric distortion.

In some instances, during the run time of the HDR processing system, the present disclosure may only take into account the information obtained from the gyroscope sensor. However, when HDR processing systems of the present disclosure are not running, additional camera information may be obtained. For example, the present disclosure can obtain sensor timing information, focal length information, and/or information concerning the distortion characteristics of the lens. Additionally, as mentioned above, the present disclosure can generate both short and long exposure frames. In some aspects, the short exposure frames may be generated before the long exposure frames. In other aspects, the long exposure frames may be generated before the short exposure frames. Accordingly, the generated exposure times can be either ascending or descending.

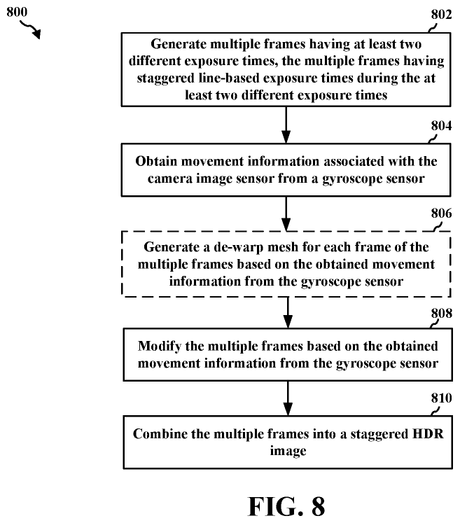

FIG. 8 illustrates an example flowchart 800 of an example method in accordance with one or more techniques of this disclosure. The method may be performed by an HDR processor or apparatus for HDR processing. At 802, the apparatus may generate multiple frames, where each frame is generated through a line-based exposure at a camera image sensor, as described in connection with the examples in FIGS. 3-5. For example, as shown in FIG. 3, short exposure frames can be generated with short exposure lines 302 and long exposure frames can be generated with long exposure lines 304. The multiple frames can have at least two different exposure times, such that the multiple frames can have staggered line-based exposure times during the at least two different exposure times, as described in connection with FIGS. 3-5. For example, as shown in FIG. 3, short exposure lines 302 and long exposure lines 304 can be staggered during the generation of short exposure frames and long exposure frames. At 804, the apparatus may also obtain movement information associated with the camera image sensor from a gyroscope sensor, as described in connection with the examples in FIGS. 4-7. For example, as shown in FIG. 4, movement information associated with the camera image sensor 402 can be obtained from gyroscope sensor 404.

At 806, the apparatus can generate a de-warp mesh for each frame of the multiple frames based on the obtained movement information from the gyroscope sensor, as described in connection with the examples in FIGS. 4-7. For example, as shown in FIG. 6, de-warp meshes 612/614 can be generated for each frame of the multiple frames based on the obtained movement information from a gyroscope sensor. At 808, the apparatus can modify the multiple frames based on the obtained movement information from the gyroscope sensor, as described in connection with FIGS. 4-7. In addition, each frame can be modified based on its corresponding generated de-warp mesh, as described in connection with the examples in FIGS. 4-7. For example, as shown in FIG. 6, frames 602/604 can be modified based on the corresponding generated de-warp meshes 612/614. The movement information associated with the camera image sensor can be obtained from the gyroscope sensor at a data acquisition frequency greater than or equal to 500 Hz, as described in connection with the examples in FIGS. 4-7. Also, the movement information can include angular velocity information, as described in connection with FIGS. 4-7.

Additionally, the movement information can include multiple sets of movement data, where each set of movement data is at a different time, as described in connection with FIGS. 4-7. Each de-warp mesh can be divided into multiple blocks bᵢⱼ, where i is the i^{th} row and 1≤i≤n, and j is the j^{th} column and 1≤j≤m of the de-warp mesh, as described in connection with FIGS. 6 and 7. For example, as shown in FIG. 6, de-warp meshes 612/614 can be divided into multiple blocks bᵢⱼ, where i is the i^{th} row and 1≤i≤n, and j is the j^{th} column and 1≤j≤m of the de-warp mesh. Also, the blocks in row i can be modified based on different sets of movement data from the movement information from a gyroscope sensor, as described in connection with FIGS. 6 and 7. In some aspects, n can be a function of a data acquisition frequency of the gyroscope sensor, as described in connection with FIGS. 6 and 7. Moreover, each block bᵢⱼ of a de-warp mesh for a frame can indicate how to rotationally modify image data within the frame that overlaps with the block bᵢⱼ, as described in connection with FIGS. 6 and 7. For example, as shown in FIG. 7, each block of a de-warp mesh for a frame can indicate how to rotationally modify image data within the frame that overlaps with the block.

In some aspects, the exposure times for multiple frames can be equal or increasing for each subsequent frame, where a last frame of the multiple frames may have a higher exposure time than a first frame of the multiple frames, as described in connection with FIGS. 4 and 5. In other aspects, the exposure times for multiple frames can be equal or decreasing for each subsequent frame, where a last frame of the multiple frames can have a lower exposure time than a first frame of the multiple frames, as described in connection with FIGS. 4 and 5. In some aspects, the multiple frames can include at least two frames, as described in connection with the examples in FIGS. 4 and 5. In other aspects, the multiple frames can include four frames, as described in connection with FIGS. 4 and 5. Further, the frames can be stored within a DRAM or an ASIC memory of an ASIC processor, as described in connection with the examples in FIGS. 4 and 5. In some aspects, the frames can be modified within the ASIC processor, as described in connection with FIGS. 4 and 5. In some aspects, the apparatus can be a wireless communication device.

At 810, the apparatus can combine the multiple frames into a staggered HDR image, as described in connection with the examples in FIGS. 4 and 5.

In one configuration, a method or apparatus for HDR processing is provided. The apparatus may be a processor, an HDR processor, an ISP, a CPU, or some other processor in a programmable device, such as a GPU. In one aspect, the apparatus may be the ISP 406/506, the CPU 408/508, the ASIC block 420/520, the HDR processor 422/522, or some other hardware component within HDR processing systems 400/500. The apparatus may include means for generating multiple frames, each frame being generated through a line-based exposure at a camera image sensor. In some aspects, the multiple frames may have at least two different exposure times, such that the multiple frames can have staggered line-based exposure times during the at least two different exposure times. The apparatus can also include means for obtaining movement information associated with the camera image sensor from a gyroscope sensor. Further, the apparatus can include means for modifying the multiple frames based on the obtained movement information from the gyroscope sensor. The apparatus can also include means for combining the multiple frames into a staggered HDR image. In some aspects, the apparatus can also include means for generating a de-warp mesh for each frame of the multiple frames based on the obtained movement information from the gyroscope sensor, where each frame is modified based on its corresponding generated de-warp mesh.

The subject matter described herein can be implemented to realize one or more benefits or advantages. For instance, the described techniques herein can be used by HDR processors or other processors to help reduce or eliminate the effects of camera motion. For instance, the present disclosure can adjust or rotate the images corresponding to different frame exposures by dividing the images into a number of different sections or blocks. By dividing the images into different sections or blocks, the adjustment or rotation process to align the frames can be much more accurate and effective. Accordingly, the present disclosure can improve the accuracy of HDR processing by adjusting or rotating different sections of images to correct for the unwanted effects of camera movement.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can be RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method of high dynamic range (HDR) processing, comprising:
generating a plurality of frames, each frame being generated through a line-based exposure at a camera image sensor, the plurality of frames having at least two different exposure times, the plurality of frames having staggered line-based exposure times during the at least two different exposure times;
obtaining movement information associated with the camera image sensor from a gyroscope sensor;
modifying the plurality of frames based on the obtained movement information from the gyroscope sensor; and
combining the plurality of frames into a staggered HDR image.

2. The method of claim 1, further comprising generating a de-warp mesh for each frame of the plurality of frames based on the obtained movement information from the gyroscope sensor, wherein each frame is modified based on its corresponding generated de-warp mesh.

3. The method of claim 2, wherein the movement information comprises a plurality of sets of movement data, each at a different time, and each de-warp mesh is divided into a plurality blocks bᵢⱼ, where i is the i^{th} row and 1≤i≤n, and j is the j^{th} column and 1≤j≤m of the de-warp mesh, and blocks in row i are modified based on different sets of movement data from the movement information from the gyroscope sensor.

4. The method of claim 1, wherein each block bᵢⱼ of a de-warp mesh for a frame indicates how to rotationally modify image data within the frame that overlaps with the block bᵢⱼ.

5. The method of claim 1, wherein the exposure times for the plurality of frames is one of:
equal or increasing for each subsequent frame, where a last frame of the plurality of frames has a higher exposure time than a first frame of the plurality of frames; or
equal or decreasing for each subsequent frame, where a last frame of the plurality of frames has a lower exposure time than a first frame of the plurality of frames.

6. The method of claim 1, wherein the movement information associated with the camera image sensor is obtained from the gyroscope sensor at a data acquisition frequency greater than or equal to 500 Hz.

7. The method of claim 1, wherein the movement information comprises angular velocity information.

8. The method of claim 1, wherein the plurality of frames comprises four frames.

9. The method of claim 1, wherein the frames are stored within one of a dynamic random access memory (DRAM) or application specific integrated circuit (ASIC) memory of an ASIC processor.

10. The method of claim 9, wherein the frames are modified within the DRAM or the ASIC processor.

11. An apparatus for high dynamic range (HDR) processing, comprising:
a memory; and
at least one processor coupled to the memory and configured to:
generate a plurality of frames, each frame being generated through a line-based exposure at a camera image sensor, the plurality of frames having at least two different exposure times, the plurality of frames having staggered line-based exposure times during the at least two different exposure times;
obtain movement information associated with the camera image sensor from a gyroscope sensor;
modify the plurality of frames based on the obtained movement information from the gyroscope sensor; and
combine the plurality of frames into a staggered HDR image.

12. The apparatus of claim 11, the at least one processor further configured to generate a de-warp mesh for each frame of the plurality of frames based on the obtained movement information from the gyroscope sensor, wherein each frame is modified based on its corresponding generated de-warp mesh.

13. The apparatus of claim 12, wherein the movement information comprises a plurality of sets of movement data, each at a different time, and each de-warp mesh is divided into a plurality blocks bᵢⱼ, where i is the i^{th} row and 1≤i≤n, and j is the j^{th} column and 1≤j≤m of the de-warp mesh, and blocks in row i are modified based on different sets of movement data from the movement information from the gyroscope sensor.

14. The apparatus of claim 11, wherein each block bᵢⱼ of a de-warp mesh for a frame indicates how to modify rotationally image data within the frame that overlaps with the block bᵢⱼ.

15. The apparatus of claim 11, wherein the exposure times for the plurality of frames is one of:
equal or increasing for each subsequent frame, where a last frame of the plurality of frames has a higher exposure time than a first frame of the plurality of frames; or
equal or decreasing for each subsequent frame, where a last frame of the plurality of frames has a lower exposure time than a first frame of the plurality of frames.

16. The apparatus of claim 11, wherein the movement information associated with the camera image sensor is obtained from the gyroscope sensor at a data acquisition frequency greater than or equal to 500 Hz.

17. The apparatus of claim 11, wherein the movement information comprises angular velocity information.

18. The apparatus of claim 11, wherein the plurality of frames comprises four frames.

19. The apparatus of claim 11, wherein the frames are stored within one of a dynamic random access memory (DRAM) or application specific integrated circuit (ASIC) memory of an ASIC processor.

20. The apparatus of claim 19, wherein the frames are modified within the ASIC processor.

21. The apparatus of claim 11, wherein the apparatus is a wireless communication device.

22. A computer-readable medium storing computer executable code for high dynamic range (HDR) processing, comprising code to:
generate a plurality of frames, each frame being generated through a line-based exposure at a camera image sensor, the plurality of frames having at least two different exposure times, the plurality of frames having staggered line-based exposure times during the at least two different exposure times;
obtain movement information associated with the camera image sensor from a gyroscope sensor;
modify the plurality of frames based on the obtained movement information from the gyroscope sensor; and
combine the plurality of frames into a staggered HDR image.
